(19) United States
(12) Patent Application Publication
(10) Pub. No.: US 2003/0065599 A1
(43) Pub. Date: Apr. 3, 2003

(54) System and method for measuring performance of trading instruments within a market

(76) Inventor: Chih-Wei Huang, Newport Coast, CA (US)

Correspondence Address: Brian M. Berliner, O'MELVENY & MYERS LLP, 400 South Hope Street, Los Angeles, CA, 90071-2899, US

(21) Appl. No.: 09/970,736

(22) Filed: Oct. 3, 2001

(51) Int. Cl. G06F 17/60

(52) U.S. Cl. 705/36

(57) ABSTRACT

A system and method is disclosed for measuring performance of trading instruments within a market. More specifically, this system comprises a generator adapted to provide the functions of determining the monetary value of each share of a particular trading instrument traded at a particular time period, determining the volume of shares traded over the particular time period, and multiplying the monetary value by the total number of shares traded to yield a trading value for the trading instrument. The time period may include an hour, a day, a week, a month, a quarter, a year, etc. The trading value may further be used to create a market index of particular trading instruments ranked in accordance with their trading value.

### BACKGROUND OF THE INVENTION

1. Field of the Invention

The present invention relates to a system and method for evaluating the performance of trading instruments within a market. More specifically, the present invention relates to a system and method for calculating a new type of performance measure of such trading instruments.

2. Description of Related Art

There are many applications in economics, marketing, supply chain management and financial markets where forecasting with the best attainable accuracy is of crucial importance. Investors often turn to theories and complex calculations in order to predict how particular markets will behave. The goal of forecasting, prediction, or valuation is thus to generate an accurate future value of a publicly-traded trading security or instrument (e.g., stocks, bonds, currency, commodities, etc.) (referred to herein as a trading instrument) directly from a given set of data pertaining to this particular trading instrument.

Although, traders may currently use different combinations of any of a plurality of performance measures (e.g., price-to-earnings ratio, market capitalization, etc.) in order to make predictions, these predictions often provide little insight on trades having a disproportionately large volume relative to the market. In particular, there are currently no reliable performance measures from which institutional investors (i.e., investors that trade in large volumes) may determine whether it is possible to trade a large number of trading instruments without adversely affecting its overall value in the market. For example, if an institutional investor is faced with the task of having to invest a disproportionately large amount of investment capital (relative to the market) into a particular stock, he/she must consider the ramifications of overwhelming the market with such a trade. As opposed to investing the entire amount of capital into the desired stock at the same time (which would likely get the attention of other investors, and thereby cause the price to rise), an institutional investor may make a number of smaller trades that are less likely to have an effect on the market. There may be certain trading investments that would be impractical for such an investor to invest in since the amount traded of these instruments is generally too low. An institutional investor considering selling a large amount of stock in a particular company would be faced with a similar dilemma. If the number of shares of stock in the company that are routinely traded on a daily basis is substantially below the volume that the investor wishes to sell, then it is unlikely that the investor could sell that volume of stock without causing the stock price to fall.

Currently, there are no performance measures that may be adequately used to guide an institutional investor in making these buying or selling decisions. Accordingly, it would be advantageous to develop a performance measure that would provide investors with a tool directed towards gaining insight on how the volume of a particular trade (or accumulation of trades) relates to the overall value of the individual shares being traded.

Another common and effective way to gain perspective on market fluctuations is to compare the movement of particular trading instruments relative to that of indices. It should be appreciated that indices are herein defined as any of a plurality of rankings determined by using any of several performance measures or combinations thereof. Although different indices are calculated in different ways, all indices measure the performance of a particular market or some subsection of it on a continuing basis throughout each trading day. By tracking an index, or a variety of indices, investors can quickly gauge market trends that may impact investment decisions. Indeed, overall market performance can be useful in making decisions about individual investments. For example, indices can function as benchmarks to compare the performance of particular trading instruments against the market in general. Furthermore, by comparing today's market movement with similar market movements from the past, an investor may gain useful insight on the best times to buy or sell.

In 1896 The Dow Jones Company took groups of stocks and averaged their prices to create the first indices, known as the Dow Jones Averages. They created four different indices: one for industrial companies, one for utilities, one for transportation companies, and a composite that included the three other indices. Initially, the Dow Jones Industrial Average was developed to represent the current business market, which in 1896 included industries such as sugar, leather, tobacco, gas, rubber and coal. The Dow Jones Industrial Average is now one of the best-known market indicators and is comprised of 30 leading companies. Calculated by adding the prices of these 30 stocks, the Dow is now considered a figure that indicates the general state of the market. Originally, the Dow divided the sum of the prices of the 30 stocks by 30, giving a true average. However, to be consistent every time a stock split or paid a dividend, the number 30 had to be adjusted. Now, over 100 years later, the sum of the prices of the 30 stocks is divided by a number less than one. Since a $1 movement in the price of a $100 stock counts equally with a $1 movement in the price of a $20 stock, the Dow Jones is considered a price-weighted index.

In the 1920s, Standard & Poor's Corporation (S&P) created separate indices that also measured the market as a whole in addition to only some sectors of the market. In 1957, when technology enabled companies to start calculating their indices on an hourly basis, S&P created the S&P 500 Index, which measured the performance of a larger proportion of the market compared to the more popular Dow Jones Industrial Index. In particular, this index tracks 500 companies in leading industries: transportation, utilities, financial services, technology, health care, energy, communications, services, capital goods, basic materials, consumer products, cyclicals and more. Many consider the S&P 500 Index the most accurate reflection of the U.S. stock market today. This high regard has led many money managers and pension plan administrators to use it as a benchmark for judging the overall performance of their fund against the stock market. Since the calculation for this index equals the price of each stock multiplied by the number of shares held by the public, the companies with the most shares make the greatest impact. This is known as a market weighted index.

Over the years, the S&P and Dow Jones indices have remained popular, leading both companies to create other indices. In addition, other companies and even the exchanges themselves have created more indices. Moreover, many institutional investors have created stock funds that attempt to mimic the performance of these and other indices. The drawbacks of such market weighted and price weighted indices, however, are their inherent subjectivity. Moreover, these indices primarily target either those companies with the most shares (i.e., market weighted indices) or those companies having the most expensive shares (i.e., price weighted indices). It is therefore difficult for investors to use the indices to make investment decisions regarding individual securities.

Accordingly, it would be desirable to provide a way to measure performance of a trading instrument that relates to the volume of shares that can reasonably be traded without affecting the market for that investment. It would also be advantageous to create an index based upon such a performance measure in order to provide a different perspective than those indices already known in the prior art.

### SUMMARY OF THE INVENTION

The present invention is directed towards a system and method for measuring the performance of trading instruments within a market. More specifically, the present invention provides a system and method for calculating a new type of performance measure pertaining to such trading instruments. In an embodiment of the invention, this system comprises a generator adapted to provide the functions of determining the monetary value of each share of a particular trading instrument traded at a particular time period, determining the volume of shares traded for the particular time period, and multiplying the monetary value by the total number of shares traded at the time period to yield a trading value for the trading instrument. Alternatively, the aforementioned performance measure may be calculated for particular intervals of time, such as hours, days, weeks, months, quarters, years, etc. The calculated performance measure may also be used to create a market index of trading instruments ranked in accordance with their trading value.

A more complete understanding of a system and method for measuring performance of trading instruments within a market will be afforded to those skilled in the art, as well as a realization of additional advantages and objects thereof, by a consideration of the following detailed description of the preferred embodiment. Reference will be made to the appended sheets of drawings that will first be described briefly.

### BRIEF DESCRIPTION OF THE DRAWINGS

FIG. 1 is a block diagram illustrating a preferred embodiment of the invention;

FIG. 2 is a block diagram illustrating an embodiment of the invention within a communications network;

FIG. 3 is a flow chart describing a procedure for calculating trading values according to an embodiment of the invention; and

FIG. 4 is a flow chart describing a procedure for generating an index according to an embodiment of the invention.

### DETAILED DESCRIPTION OF THE PREFERRED EMBODIMENT

The present invention satisfies the need for an improved system and method for evaluating the performance of a trading instrument within a market. More specifically, the present invention satisfies the need for a system and method for measuring performance of a trading instrument that relates to the volume of shares that can be traded without adversely affecting the market for that instrument. In particular, the present invention creates a new type of performance measure, herein referred to as “trading value”, that is calculated according to the trading volume (i.e., number of shares traded) of a particular trading instrument and its corresponding unit price (i.e., the price of each share). In the detailed description that follows, like element numerals are used to describe like elements illustrated in one or more of the figures.

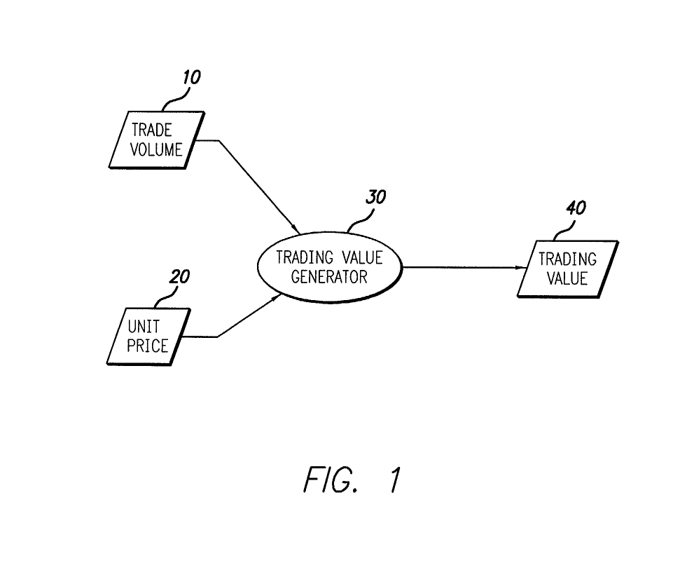

Referring to FIG. 1, a block diagram illustrating a preferred embodiment of the invention is provided. As illustrated, trade volume 10 and unit price 20 are input to trading value generator 30 in order to generate trading value 40. In a preferred embodiment, trading value generator 30 represents a multiplier that multiplies trade volume 10 by unit price 20 in order to calculate a particular trading value 40. This preferred embodiment might thus be defined by the following equation:

TradingValue=(Unit)×(Volume)

where unit price 20 (Unit) is defined as the monetary value of each share traded during a given time, and trade volume 10 (Volume) is defined as the total number of shares traded at this given time. By way of example, it should then be apparent that if, at a given time, ten shares of a particular trading instrument are purchased at $10 per share, then the trading value of this trading instrument at this given time is $100.

It should be appreciated that, within the aforementioned embodiment, trading value 40 is derived without distinguishing between individual buyers and sellers of the trading instrument, although alternative embodiments may take this distinction into account. For example, if at a given time, trader “A” purchases eight shares of a particular trading instrument at $10 per share, and trader “B” purchases two shares of the same trading instrument also at $10 per share, then the resulting trading values 40 for investors A and B would be $80 and $20, respectively. In this example, it should therefore be clear that, although the trading value 40 of this trading instrument is $100 as previously calculated, different trading values pertaining to trades made by individual traders of this trading instrument might similarly be obtained.

In another embodiment of the present invention, aggregate trading values 40 may be obtained for particular intervals of time. For example, a daily trading value 40 for a particular trading instrument may be obtained by taking the sum of all trading values 40 for that day pertaining to this instrument. More specifically, this daily trading value 40 may be obtained using the following equation:

$$T r a d i n g V a l u e ( d a y ) [ U n i t , V o l u m e ] = {\sum }_{i = 1}^{j} [ {( U n i t )}_{i} \times {( V o l u m e )}_{i} ]$$

where it is understood that this daily trading value is the sum of all trading values 40 for that particular day. It should be appreciated that, within this example, a plurality of instants in time for this particular day is given by the interval [i, j]. In particular, this daily trading value is the sum of j trading values 40 individually calculated by respectively multiplying the unit price (Unit)ᵢ at a given time by its corresponding (i)trade volume (Volume)ᵢ.

In an alternative embodiment, a daily trading value may be calculated by taking the total number of trades in a given day and multiplying it by the average unit price of the trading instrument for the desired day. Within such embodiment, it should thus be appreciated that a daily trading value may be obtained by using the equation:

$$T r a d i n g V a l u e ( d a y ) [ Avg U n i t , V o l u m e ] = Avg U n i t {\sum }_{i = 1}^{j} [ {( V o l u m e )}_{i} ]$$

where it is understood that this daily trading value is calculated by taking the average unit price (AvgUnit) of the trading instrument for that particular day and multiplying it by the total trade volume for that day. It should be further understood that, in the equation above, j represents the sum of all individual “trade volumes” taken at every i-th interval of a given day. Nevertheless, any of a plurality of temporal types of trading values (e.g., hourly, daily, weekly, monthly, quarterly, annually, etc.) may similarly be derived.

An exemplary investor can use the trading value information, alone or in conjunction with other performance measures, to select individual securities for investment. For example, an institutional investor desiring to make a substantial investment in the market (e.g., several millions of dollars) may consult the trading value information to select securities that can absorb a sizable investment without having an adverse market reaction. If the stock of a particular company has a daily trading value in excess of $500 million, then the purchase of $1 million of that stock would likely not affect the market price. In contrast, the stock price of another company that has a daily trading value under $5 million would likely be very affected by a $1 million stock purchase. For yet another company having a daily trading value under $1 million, it may not be possible to acquire $1 million worth of stock since an insufficient amount of stock is traded to satisfy such a large purchase. The availability of trading value information can therefore benefit greatly an investor's trading decisions.

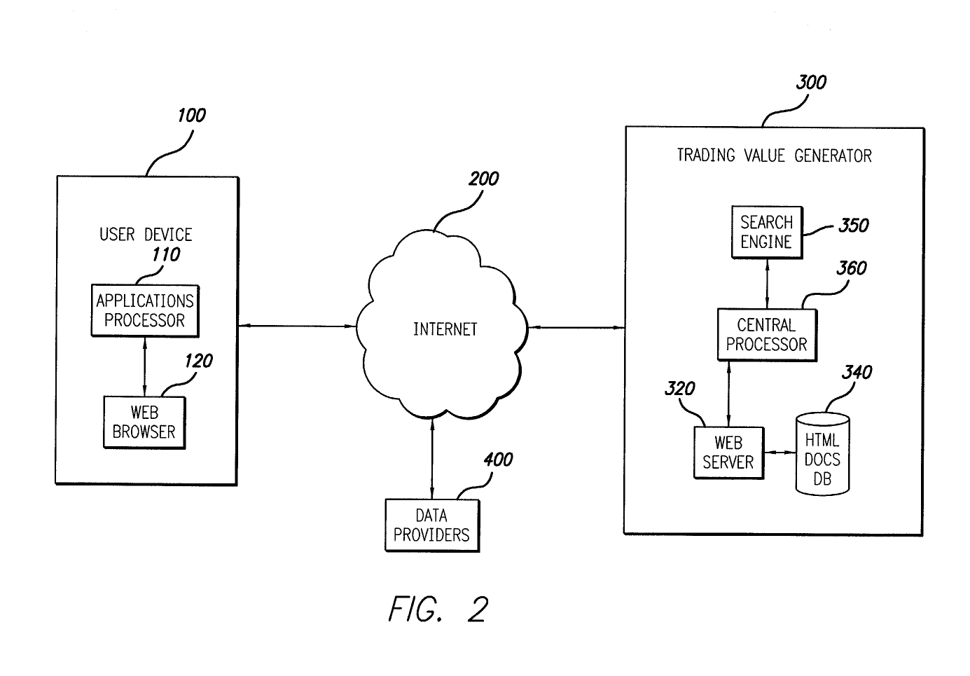

It should be appreciated that any of the aforementioned embodiments may also be implemented within a communications network, such as the Internet, so that users may obtain trading value information from remote locations. In FIG. 2, a block diagram of one such implementation is provided. In particular, a trading value generator 300 is shown to be connected to a user device 100 and various data providers 400 via the Internet 200. Although the Internet is used in this particular example, it should be noted that equivalent communication mediums might include local area networks (LANs), wide area networks (WANs), and other communication systems and networks.

Within such embodiment, it should be appreciated that trading value generator 30 may be implemented as an application accessible through an Internet interface, such as the World Wide Web, using conventional interface protocols such as TCP/IP. As illustrated in FIG. 2, trading value generator 300 is shown to be comprised of a central processor 360 coupled to a search engine 350, and a Web server 320 connected to an HTML documents database 340. Meanwhile, user device 100 is shown to be further comprised of an applications processor 110 coupled to a Web browser 120. Within such embodiment, it should be further appreciated that user devices 100, trading value generator 300, and data providers 400 may comprise a computing device, such as a personal computer, laptop, personal digital assistant, and the like.

As is generally known in the art, search engines such as search engine 350 typically incorporate a database engine, such as a SQL Server™ engine from Microsoft Corporation or Oracle™ database engine, as part of their architecture. It is also well known in the art that such search engines typically perform searches by operating on a string of characters, known as a “query string.” A query string is coded according to a set of rules determined by the database engine and/or a user interface between the database engine and the user. As used herein, a “query” is broader than a “query string,” denoting both the query string and the search logic represented by the query string, whereas “query string” refers only to a string of characters, symbols, or codes used to define a query.

As is also generally known in the art, Web servers such as Web server 320 access a plurality of Web pages, distributable applications, and other electronic files containing information of various types stored in HTML document database 340. As a result, Web pages may be viewed on various user devices 100; for example, a particular Web page or other electronic file may be viewed through a suitable application program residing on a user device 100, such as a browser 120 or by a distributable application provided to the user device 100 by Web server 320. It should be appreciated that many different user devices 100, data providers 400, and many different Web servers 320 may be communicating with each other at the same time.

It should be further appreciated that user devices 100 may be represented by any type of the aforementioned computing devices that allow a user to interactively browse websites, such as a personal computer (PC) that includes a Web browser application 120 (e.g., Microsoft Internet Explorer™ or Netscape Communicator™). Suitable user devices 100 equipped with browsers 120 are available in many configurations, including handheld devices (e.g., PalmPilot™), personal computers (PC), laptop computers, workstations, television set-top devices, multi-functional cellular phones, and so forth.

Within this embodiment, a user device 100 identifies a Web page that is desired to be viewed at the user device 100 by communicating an HTTP (Hyper-Text Transport Protocol) request from the browser application 120. The HTTP request includes the Uniform Resource Locator (URL) of the desired Web page, which may correspond to an HTML document stored in the HTML documents database 340. The HTTP request is routed to the Web server 320 via the Internet 200. The Web server 320 then retrieves the HTML document identified by the URL, and communicates the HTML document across the Internet 200 to the browser application 120. The HTML document may be communicated in the form of plural message packets as defined by standard protocols, such as the Transport Control Protocol/Internet Protocol (TCP/IP).

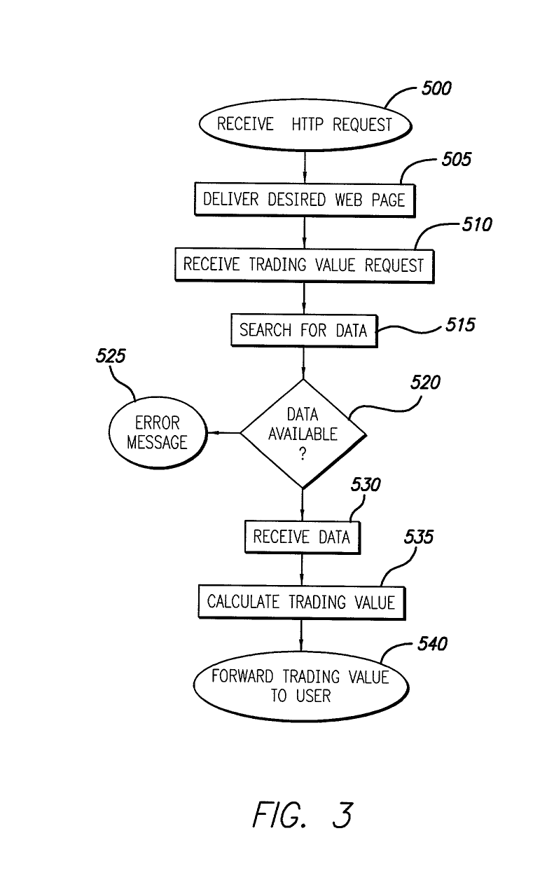

Referring to FIG. 3, a flow chart illustrating the procedure followed by the trading value generator 300 within this embodiment is provided. This procedure begins at step 500 when the trading value generator 300 receives an HTTP request from a user device 100. At step 505, the trading value generator 300 then delivers the requested Web page to the user device 100. Once the user device 100 has obtained access to the trading value generator 300, a user may choose to ascertain any of a plurality of trading values 40 available. In particular, a user may choose to obtain trading values 40 of any trading instrument available to the trading value generator 300 from data providers 400.

Once the user has selected which trading value 40 it desires, the trading value generator 300 receives this request at step 510. The trading value generator 300 then proceeds by searching for the data necessary for calculating the requested trading value 40 at step 515. In particular, trading value generator 300 uses search engine 350 in order to search for relevant data (i.e., trade volume 10 and unit price 20) pertaining to this calculation from databases provided by any of various data providers 400.

At step 520, the trading value generator 300 then determines whether it has sufficient data to calculate the requested trading value 40. If sufficient data is not available at step 520, then the trading value generator 300 proceeds by sending the user device 100 an error message at step 525; otherwise, the necessary data is received from data providers 400 at step 530. At step 535, the requested trading value 40 is then calculated using the data received at step 530. Once this trading value 40 is calculated, the trading value generator 300 then concludes this procedure by forwarding this value to user device 100 at step 540.

It should be appreciated that, once a trading value 40 has been generated using any of the aforementioned embodiments, any of a plurality of indices may be readily created. Moreover, it should be appreciated that this trading value 40 may be used either alone or in conjunction with other performance measures in order to create an index. By creating such an index, investors may thus gain perspective on market fluctuations by comparing the movement of particular trading instruments relative to that of other trading instruments within the newly created index. As a result, investors are provided with a tool that monitors volume-dependent market trends that may impact investment decisions.

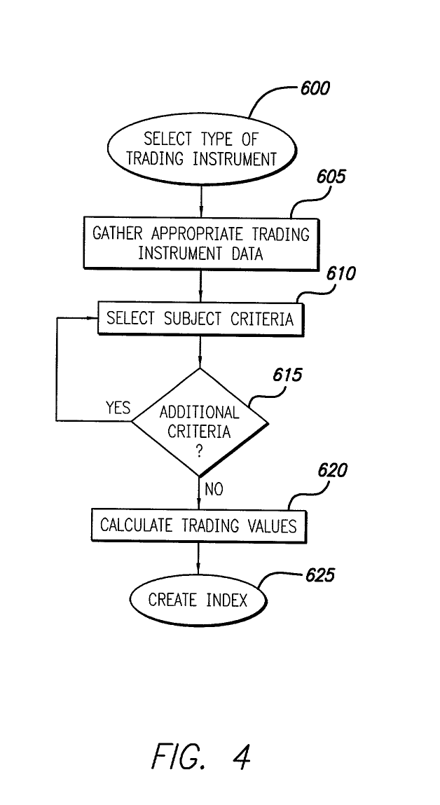

Referring to FIG. 4, a flow chart illustrating the procedure for generating an index according to an embodiment of the invention is provided. It should be appreciated that, although the following procedure is described with respect to a particular investor, these steps may be similarly followed by any instrument attempting to create an index. An investor initiates this procedure, at step 600, by selecting a particular type of trading instrument (e.g., stocks, bonds, currency, commodities, etc.) from which to index. At step 605, the investor then ascertains a list of all trading instruments corresponding to the selection made at step 600. From this list, the investor would then extract a subset of trading instruments pertaining to specific categories (i.e., trading instruments pertaining to a specific industry, trading instruments typically traded in high/low volumes, etc.) by selecting desired criteria at step 610.

After having generated a particular subset of trading instruments at step 610, the investor must then determine if it wants to further narrow this subset to include only those trading instruments that comply with an additional criteria at step 615. More specifically, if the investor chooses to revise its subset at step 615, then the investor returns to step 610 where it selects an additional criteria from which to further narrow the current subset; otherwise, the investor proceeds by calculating trading values 40 for each trading instrument within the generated subset at step 620. Once these trading values 40 are calculated, the investor may then create an index by ranking individual ones of these trading instruments according to an algorithm that is weighted towards these respective trading values 40 at step 625.

It is envisioned that such an index based on trading value may be publicly disseminated in the form of a publication or report to investors. The index would include companies ranked in order of their trading value based on a daily, weekly, monthly, quarterly, annual or other perspective. Moreover, stock funds may be formed that focus entirely or at least partially on investments within companies listed on such an index. Exemplary indices may include the five-hundred companies having the largest trading value (LTV 500), the one-hundred companies having the largest trading value (LTV 100), or other similar rankings.

Having thus described a preferred embodiment of a system and method for calculating a performance measure of trading instruments within a market, it should be apparent to those skilled in the art that certain advantages of the within system have been achieved. It should also be appreciated that various modifications, adaptations, and alternative embodiments thereof may be made within the scope and spirit of the present invention. The invention is further defined by the following claims.

What is claimed is:

1. A method for measuring performance of a trading instrument, comprising the steps of:
determining monetary value of shares of a particular trading instrument traded during a particular time period;
determining volume of said shares traded over said particular time period; and
multiplying said monetary value with said volume of shares traded to determine a trading value of said trading instrument for said time period.

2. The method of claim 1, wherein said time period further comprises a plurality of successive time periods.

3. The method of claim 1, wherein said time period is selected from a group including an hour, a day, a week, a month, a quarter, and a year.

4. The method of claim 2, wherein said first determining step further comprises determining said volume for each of said plurality of time periods.

5. The method of claim 4, wherein said second determining step further comprises determining said monetary value for each of said plurality of time periods.

6. The method of claim 5, wherein said multiplying step further comprises multiplying said monetary value with said volume for each of said plurality of time periods to provide corresponding trading values, and summing together said trading values corresponding to each of said plurality of time periods to yield a combined trading value for a time duration corresponding to said plurality of time periods.

7. The method of claim 2, further comprising calculating an average of said monetary value pertaining to said time period.

8. The method of claim 1, further comprising generating an index of trading instruments ranked in accordance with said trading value.

9. The method of claim 1, wherein said trading instrument is selected from a group comprising stocks, bonds, currencies, commodities and the like.

10. An index generated in accordance with the method of claim 1.

11. A system for measuring performance of a trading instrument, comprising:
a generator adapted to provide the functions of:
determining monetary value of shares of said trading instrument traded during a particular time period;
determining volume of said shares traded over said particular time period; and
multiplying said monetary value with said volume of shares traded to determine a trading value of said trading instrument for said time period.

12. The system of claim 11, wherein said time period further comprises a plurality of successive time periods.

13. The system of claim 11, wherein said time period is selected from a group including an hour, a day, a week, a month, a quarter, and a year.

14. The system of claim 14, wherein said first determining function further comprises determining said monetary value for each of said plurality of time periods.

15. The system of claim 12, wherein said second determining function further comprises determining said volume for each of said plurality of time periods.

16. The system of claim 15, wherein said multiplying function further comprises multiplying said monetary value with said volume for each of said plurality of time periods to provide corresponding trading values, and summing together said trading values corresponding to each of said plurality of time periods to yield a combined trading value for a time duration corresponding to said plurality of time periods.

17. The system of claim 12, wherein said generator is further adapted to calculate an average of said monetary value pertaining to said time period.

18. The system of claim 11, wherein said generator is further adapted to generate an index of trading instruments ranked in accordance with said trading value.

19. The system of claim 11, wherein said trading instrument is selected from a group comprising stocks, bonds, currencies, commodities and the like.
